(19) United States
(12) Patent Application Publication
(10) Pub. No.: US 2011/0302099 A1
(43) Pub. Date: Dec. 8, 2011

(54) APPARATUS, SYSTEM, AND METHOD FOR PROVIDING A SOCIAL NETWORK

(76) Inventor: James Jeffries, Salt Lake City, UT (US)

(21) Appl. No.: 13/154,267

(22) Filed: Jun. 6, 2011

Related U.S. Application Data
(60) Provisional application No. 61/351,716, filed on Jun. 4, 2010.
(60) Provisional application No. 61/358,781, filed on Jun. 25, 2010.

(51) Int. Cl. G06Q 99/00

(52) U.S. Cl. 705/319

(57) ABSTRACT

An apparatus, system, and method are disclosed for providing a social network. An apparatus for a social network includes an account module, a connection module, and a network visibility module. The account module is configured to manage a plurality of account types, the account types including a first account type, a second account type, and an administrator account type. The connection module allows for the forming of connections between specific accounts wherein the connections are allowed to be formed based on at least the account types of the specific accounts. The network visibility module regulates the amount of details of an account that are visible to other account. The visibility of the details of the account are based on at least the account type of the account. The accounts of different types include permissions that are unequal in relation to each other. Each level of permissions includes limitations at least partially defined by one or more of the connection module and the network visibility module.

### CROSS-REFERENCE TO RELATED APPLICATIONS

This application claims priority to U.S. Provisional Patent Application No. 61/351,716 entitled “Multi-Tiered Professional Networking Platform with the Integration of the Professional Experience Matrix and Consult Connect Dashboard” and filed on 4 Jun. 2010 for James Jeffries and also claims priority to U.S. Provisional Patent Application No. 61/358,781 entitled “Apparatus, System, and Method for Providing a Social Network” and filed on 25 Jun. 2010 for James Jeffries, which are both incorporated herein by reference.

### BACKGROUND

1. Field

This invention relates to social networks, job boards, and work experience layouts, and more particularly relates to multi-tiered networks, job boards integrated within social network platforms, criteria matched indicators, and presenting a stratified view of work experience.

2. Description of the Related Art

With the advent of the internet and personal computing devices social networking websites have helped to connect individuals and entities throughout the world. Social networking websites have been used to provide easy and simple ways of staying in contact with friends and family as well as provide the ability to network with new people and create new relationships. Social networking websites have also assisted individuals in gaining new employment and/or employees.

However, existing social networking sites have considerable drawback when compared to normal human relations. For example, such sites often fail to reflect the tiered nature of human relations, such as those found in organizations such as corporations or between a customer and goods/service provider. Thus, a single account type is generally insufficient to capture the intricacies of human relations. Additionally, social networking sites often fail to provide sufficient utility to motivate individuals or organizations to post updated information on the site. Thus, when individuals or entities are in need of services, goods, or employment they often turn to other sources or methods to satisfy these needs.

### BRIEF SUMMARY

From the foregoing discussion, it should be apparent that a need exists for a method and apparatus that overcome the drawbacks found in social networks. Beneficially, such a method and apparatus would better reflect the tiered nature of human relations.

The present invention has been developed in response to the present state of the art, and in particular, in response to the problems and needs in the art that have not yet been fully solved by currently available social networking methods. Accordingly, the present invention has been developed to provide a method and apparatus for social networks that overcome many or all of the above-discussed shortcomings in the art.

An apparatus for providing a social network is discussed. An apparatus for a social network includes an account module, a connection module, and a network visibility module. The account module is configured to manage a plurality of account types, the account types including a first account type, a second account type, and an administrator account type. The connection module allows for the forming of connections between specific accounts wherein the connections are allowed to be formed based on at least the account types of the specific accounts. The network visibility module regulates the amount of details of an account that are visible to other account. The visibility of the details of the account are based on at least the account type of the account. The accounts of different types include permissions that are unequal in relation to each other. Each level of permissions includes limitations at least partially defined by one or more of the connection module and the network visibility module.

In one embodiment, an account of the first account type includes permissions that allow a first level of access to an account of the second account type and the account of the second account type includes a second level of access to the account of the first account type, wherein the first level of access is less than the second level of access. In one embodiment, the first level of access includes not being allowed to see the existence of the account of the second account type and the second level of access includes being allowed to see the existence of the account of the first account type. In one embodiment, the first level of access includes not being allowed to initiate a connection to the account of the second account type and the second level of access includes being allowed to initiate a connection to the account of the first account type.

In one embodiment, the first account type includes an account for one or more of a service provider and a goods provider. In one embodiment, the first account type includes an account for consultants. In one embodiment, the second account type includes an account for one or more of a purchaser of goods and a purchaser of services. In one embodiment, the second account type includes an account for customers.

In one embodiment, the administrator account type includes unrestricted access to see the existence of accounts of all account types and non-private data stored by all account types. In one embodiment, the second account type includes a silo account type, wherein the silo account type is granted administrator like permissions to one or more accounts of the first account type based on a matching detail found in each of the one or more accounts of the first account type. In one embodiment, the administrator like permissions include unrestricted access to see the existence of accounts of the one or more accounts of the first account type and non-private data stored by the one or more accounts of the first account type.

According to one embodiment, the apparatus further includes a query module configured to provide one or more search features for locating one or more accounts. In one embodiment, the apparatus further includes a profile module for receiving and storing one or more details entered in relation to an account.

In one embodiment, accounts of the first account type form a first network and accounts of the second account type form a second network, wherein the social network comprises the first network and the second network.

A computer program product for providing a social network is also discussed. The computer program product may provide any of the functionality or steps discussed in relation to the apparatus. In one embodiment, the computer program product includes a computer readable storage medium having computer readable program code embodied therein. The computer readable program code may be configured to manage a plurality of account types, the account types including a first account type, a second account type, and an administrator account type. The computer readable program code may be configured to allow forming of connections between specific accounts wherein the connections are allowed to be formed based on at least the account types of the specific accounts. The computer readable program code may be configured to regulate the amount of details of an account to be visible to other accounts, wherein the visibility of details of the account are based on at least the account types of the other accounts. The computer readable program code may be configured wherein accounts of different types include permissions that are unequal in relation to each other, each level of permissions including limitations at least partially defined by the allowing forming of connections and the regulating the amount of details that are visible.

In one embodiment, the plurality of account types further include one or more account types in addition to the first account type, the second account type, and the administrator account type.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of an apparatus for providing a social network in accordance with the present invention;

FIG. 2 is a schematic block diagram illustrating one embodiment of a network module in accordance with the present invention;

FIG. 3 is a schematic block diagram illustrating possible account types in accordance with one embodiment of the present invention;

FIG. 4 is a schematic block diagram illustrating the visibility of account types on a social network in accordance with one embodiment of the present invention;

FIG. 5 is a schematic block diagram illustrating the relation of a silo account to other account types on a social network in accordance with one embodiment the present invention;

FIG. 6A is a schematic block diagram illustrating exemplary connections between account types on a social network in accordance with one embodiment the present invention;

FIG. 6B is a schematic block diagram illustrating exemplary connections between social networks and account types on a social network in accordance with one embodiment the present invention;

FIG. 7 is a schematic block diagram illustrating one embodiment of a display provided by a profile module in accordance with the present invention;

FIG. 8 is an exemplary webpage view illustrating one embodiment for entering work experience data in accordance with the present invention;

FIG. 9 is an work experience view illustrating one embodiment for displaying work experience data in accordance with the present invention;

FIG. 10 is an exemplary webpage view illustrating one embodiment for entering individual dashboard attributes data in accordance with the present invention;

FIG. 11 is an exemplary webpage view illustrating one embodiment for entering a firm's dashboard attributes data in accordance with the present invention;

FIG. 12 is a schematic block diagram illustrating one embodiment of an indicator module in accordance with the present invention;

FIG. 13 is a schematic block diagram illustrating one embodiment of a query module in accordance with the present invention;

FIG. 14 is an exemplary view of a dashboard attribute search page in accordance with the present invention;

FIG. 15 is a schematic block diagram illustrating one embodiment of a job board module in accordance with the present invention;

FIG. 16 is an exemplary view of a job posting in accordance with the present invention;

FIG. 17 is an exemplary view of a resume in accordance with the present invention;

FIG. 18 is a schematic block diagram illustrating exemplary operations of a job board in connection with a social network in accordance with the present invention; and

FIG. 19 is a schematic flow chart diagram illustrating an exemplary method of receiving job applications

### DETAILED DESCRIPTION

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

Social networks generally include a theoretical structure that controls, or reflects, the ways users interact. Generally, the structure of social networks includes a plurality of nodes (accounts) and a plurality of ties (connections) between the nodes. The nodes often represent a user, such as an individual or entity, while the ties between the nodes often represent some type of connection or relationship between the nodes. In some social networks the ties may reflect friendship, employment, acquaintanceship, or some other type connection or relationship. These social networks may then allow one node, or user, to take advantage of these ties by offering related services.

Although the following disclosure will concentrate on embodiments applicable to a social network for consultants and customers of consultants, one of skill in the art will understand that the principles and teachings provided herein may apply to a variety of other environments and situations as well.

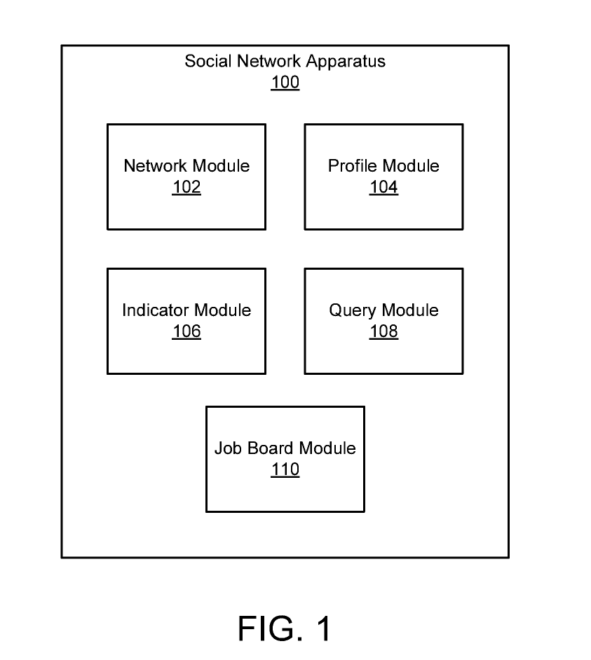

FIG. 1 is a schematic block diagram depicting an exemplary social network apparatus 100 for providing a social network. The social network apparatus 100, as depicted, includes a network module 102, a profile module 104, an indicator module 106, a query module 108, and a job board module 110. A brief description of each module 102-110 will be provided followed by additional description in relation to the remaining figures.

The network module 102 may manages and/or provide the nodes and ties (connections) of a social network and may facilitate the basic structure of the social network. The network module 102, according to one embodiment, provides and/or manages one or more accounts that may act as nodes on a social network. According to one embodiment, the network module 102 provides a variety of account types. The network module 102 may provide and/or manage ties, or connections, between the accounts. The network module 102 may allow or restrict how, when, and by whom connections are formed. For example, an account of one type may not be allowed to initiate a connection with an account of another type. The network module 102 may also limit the visibility of accounts to other accounts.

Additionally, sub-networks and/or accounts of different types within a social network may have unequal levels of permissions. For example, an account of a first account type may have a first level of access to an account of a second account type while the account of the second account type may have a second level of access to the account of the first account type. The first level of access and the second level of access such that accounts of different types may be able to see varying amount of details in relation to each other. For example, a first account may not be allowed to see that a second account exists while the second account is allowed to see the existence of the first account. The level of access may vary in relation to visibility of information in a profile, ability to initiate connections, etc.

In some embodiments, further account types and/or levels of access may be present in some embodiments. For example, a third, fourth, fifth, or more types of accounts may be present in some embodiments. Similarly, additional levels of access may be present in some embodiments.

The profile module 104 manages profiles that correspond to accounts. The profiles module 104 may provide features that allow entry of information that correspond to a user of a specific account. For example, the profile module 104 may allow entry of a user's work experience, current work attributes or desires, personal information, public information, etc. The profile module 104 may provide different features or different types of profiles depending on the type of account. The profile module 104 may also provide features that combine data provided by an individual to create a portion of a resume.

The indicator module 106 creates indicators that reflect the degree of similarity or matching between at least two sets of data. According to one embodiment, the indicator module 106 compares an attribute or an item of work experience data with a requirement for employment. The indicator module 106 may then return an indicator that reflects the degree of similarity. The indicator may include a color, a number, a word, a graph, or other graphic that indicates how well the two sets of data match.

The query module 108 provides features that allow for searches to be made against one or more accounts, or other sets of data, to locate accounts or data that corresponds to the search. The query module 108 may provide an interface that allows a search to be made against one or more accounts based on work experience, or other attributes of a user. The query module 108 may also allow a search for a job posting on a job board that corresponds to a set of requirements, or attributes of a user.

The job board module 110 provides a job board that may be used by potential employers to locate skilled individuals or firms as well as by individuals or firms to locate employment. The job board module 110 may provide features allowing a potential employer to post details regarding an employment position or project which then may be available for others to see and apply. The posted position or project may be directed towards finding individuals to provide consulting services or towards finding a complete team. The job board module 110 may also provide features allowing a potential employee, firm, or team to apply for the position and may pull data from an account to provide the details for a job application. The job board may be used to post requests for one time services, contract positions, or long term employment. The job board may allow for the posting of a job posting that may require a team of individuals. For example, the job posting may allow multiple individuals to apply to fulfill separate aspects of the job posting. The poster of the job may then be able to select one or more individuals to fulfill the job requirements as a team. The depicted social network apparatus 100 and modules 102-110 are exemplary only and illustrate only one of many possible embodiments. Other embodiments may include only one of the modules 102-110, or any combination of the modules 102-110. Additionally, in some embodiments, the modules 102-110 may operate separate from the social network apparatus 100. For example, a system that includes one or more of the modules 102-110 may be used to provide functionality similar to the social network apparatus 100.

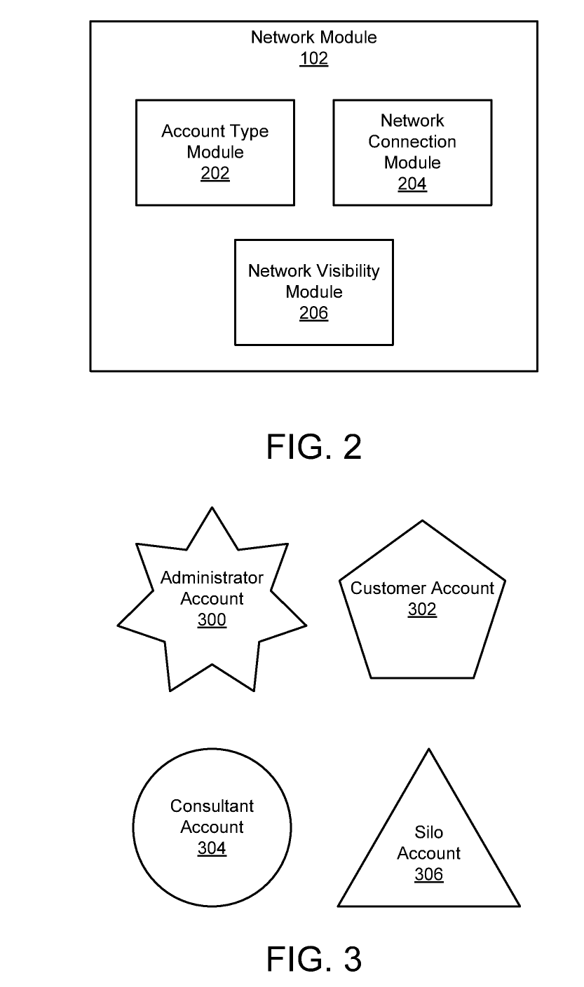

Turning now to FIG. 2 a schematic diagram of one embodiment of a network module 102 is shown. The network module 102 is configured to provide a social network structure that includes a plurality of accounts (nodes) and connections (ties). The network module 102 regulates the type of accounts, the connections between accounts, and the visibility of accounts to others within and outside the social network. The network module 102 as depicted includes an account type module 202, a network connection module 204, and a network visibility module 206.

The account type module 202, according to one embodiment, allows one or more account types to be created. The account types may have varying features or attributes that allow different account types to behave differently on a social network. The account type module 202 may have access to a data store for accessing or storing information regarding the type of an account.

According to one embodiment, an individual attempting to access a social network website will be prompted to create an account or provide login details. If the individual does not yet have an account, the account type module 202 may allow the individual to proceed through a registration process to create an account. In some embodiments, a plurality of account types may be available. Some account types may allow immediate online creation while other account types may require creation in another manner, such as by telephone or in person.

According to one embodiment, a person's or entity's identity may be verified to determine the account user's level of credibility. In one embodiment, the level of credibility may be evaluated before the individual or entity is allowed to create an account. In one embodiment, an account may be created prior to verification but various features may be disabled until a person's or entity's identity is verified. In one embodiment, one or more details besides identity may be verified prior to account creation or enablement of features. For example, a background check, an employment verification, an employment history verification, or other details with regard to an individual or entity may be verified. The identity or details may be verified by an owner of a social network or by some other third party.

In one embodiment, having a third party perform an evaluation of an individual on the social network may allow for significant level of trust. For example, if an account simple endorsements from other accounts or individuals on the social network may not be as trustworthy because the credibility of the endorsing account may not be verifiable. Thus, you may have two unknowns endorsing each other with no real way of verifying that the individuals or entities are who they say they are. Third party verification by the owner of the social network or some other entity may help customers or those seeking goods or services to receive have trust that the details of a profile or job application are accurate.

The network connection module 204 manages network connections (ties) between accounts on a social network. The network connection module 204 may allow one or more connection types between accounts. The network connection module 204 may restrict the creation of a connection based on the account type initiating a connection, the account type being solicited for a connection, existing connections between accounts, and the method used to create the connection. According to one embodiment, the connections between accounts are stored in a data store accessible by the network connection module 204. According to another embodiment, the connections of a given account are stored in that account.

In one embodiment, the network connection module 204 allows unequal permission to form or initiate connections between accounts of different types. For example, an account of a first account type may not be allowed to initiate a connection with an account of a second account type while the account of the second account type is allowed to initiate a connection with the account of the first account type.

In one embodiment, different methods of initiating a connection may be available. For example, one account may be able to initiate a connection with any other account it can see as existing through the social network or the account may be able to send an email request to connect to any email address. In one embodiment, a user of one account type may send an email to another individual or entity for whom the user has an email address despite whether or not the user knows if the other individual or entity has a social network account. Upon receipt of the email request, the other individual or entity may accept or deny the request by adding the connection to an existing account (such as an account the individual or entity already has on the social network) or by creating a new account.

The network visibility module 206 manages the visibility of accounts to other accounts in the social network. The network visibility module 206 may also manage the visibility of accounts from outside the social network. According to one embodiment, the network visibility module may regulate whether an account can be seen to exist by another account. According to one embodiment, the network visibility module may regulate whether at least a portion of a profile corresponding to the account is at least partially visible to another account.

According to one embodiment, the network visibility module 206 allows different account types to have different visibility within the network. For example, a second account type may be able to see a first account type while the first account type may not be able to see the second account type. According to one embodiment, the network visibility module 206 allows visibility based on connections between accounts. According to one embodiment, an account may be visible to all other accounts with which it has a connection, regardless of account type.

The network visibility module 206 may regulate whether an account can be seen to exist and/or how much of an account, for example details entered within a profile of an account, is visible. In one embodiment, an account may be able to see all public details entered in relation to another account. In one embodiment, an account may only be able to see that another account exists and/or a name of the account. In one embodiment, an account may not be allowed to see that another account exists at all.

The visibility of a first account to a second account may depend on one or more of a variety of factors. In one embodiment, the visibility may depend on one or both of the account type of the first account and the account type of the second account. In one embodiment, the visibility may depend on whether or not there is a connection between the first account and the second account.

In one embodiment, each account includes a number of permissions that define what that specific account can see and/or do within the social network. In one embodiment, the permission may be embodied by the type of account and how the type of account is regulated by one or more modules. In one embodiment, the permission may be embodied in connections between accounts. The permissions for each account may be stored within the account or may be calculated each time the account attempts to view another account or do something. For example, one or more modules that regulate activities or visibility on the social network may regulate the actions of an account. In one embodiment, the network visibility module 206 and the network connection module 204 may define the permissions of the accounts based on one or more of the account type and connections between accounts.

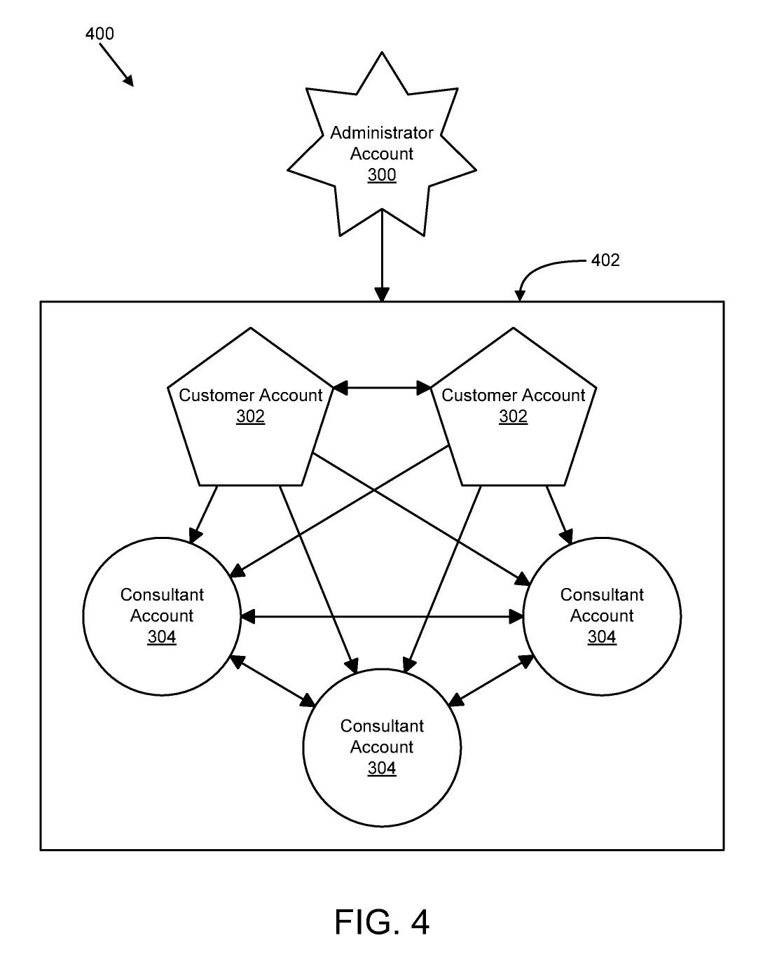

Exemplary operation and features of the network module 102 will now be discussed in relation to FIGS. 3-6. FIG. 3 is a schematic diagram illustrating exemplary account types 300-306 provided and/or managed by the account type module 202 in a social network designed to connect those needing consulting services to those providing consulting services. The exemplary account types depicted include an administrator account 300 type, a consultant customer account 302 type, a consultant account 304 type, and a silo account 306 type. The shapes of the exemplary account types 300-306 are for illustrating that the account types may have different attributes and/or permissions and may help lead to simplicity and ease in understanding FIGS. 4-6.

It is important to note that the account types depicted are only exemplary. Accounts of different types may be added or replace the account types discussed in FIGS. 3-6. For example, an additional supplier account type may exist in some embodiments. Other types of accounts may also be enabled and created in other embodiments.

An administrator account 300 may be created for the owner or provider of a social network. In one embodiment, the administrator account 300 may include almost an unlimited level of permission. As such, the administrator account 300 may provide almost unlimited access to view other accounts and any data stored therein. In one embodiment, no other account, including an administrator account, is allowed to see password information and/or data marked as private. According to one embodiment, there is only a single administrator account 300 that is accessible to the owner or provider of the social network. Other embodiments may allow multiple administrator accounts 300. According to one embodiment, the administrator account 300 may be invisible to all other accounts regardless of account type.

A customer account 302 type may be created for use by individuals or entities that need consulting services. According to one embodiment, a customer account 302 is allowed to see all other customer accounts 302 as well as consultant accounts 304. According to another embodiment, a customer account 302 is allowed to see all other account types except an administrator account 300. The customer account 302 may also be visible to other accounts of the same type but not to consulting accounts 304, according to one embodiment. A customer account 302 may be provided with features that assist a user to locate a consultant that is providing needed services. For example, the customer account 302 may be provided with the ability to search the profiles of consultant account 304 accounts for individuals having the proper qualifications and attributes. Additionally, a customer account 302 may be able to form connections with other accounts.

A consultant account 304 may be created for use by individuals or entities that provide consulting services. According to one embodiment, only consultant accounts 304 are visible to an account of the consultant account 304 type. A consultant account 304 may be provided with features that assist an individual or entity in being located by a customer needing the individual's or entity's services. For example, the consultant account 304 may be provided with a profile where information regarding the services and attributes of the individual or entity may be entered, and this information may be made searchable. Additionally, a consultant account 304 may be able to form connections with other accounts.

In one embodiment, a consultant account 304 includes a very limited level of permissions and may have the lowest level of permission of any account 300-306 on a social network. In one embodiment, the consultant account 304 may include the most extensive profile of any of the accounts 300-306 on the network.

In one embodiment, the tiered nature of a social network including the different types of accounts 300-306 may facilitate the finding of a consultant to offer services. For example, the consultant account 304 may be visible to all other accounts while it can only see other consultant accounts 304. This may enable those looking for a consultant to find a consultant that best matches specific needs. The consultants that correspond to the consultant accounts 304 may be motivated to keep updated profiles so that other accounts can locate them. On the other hand, if other accounts are invisible to the consultant accounts 304 the entities or individuals corresponding to the customer accounts 302 may be motivated to get on the social network without fear of receiving too many requests for employment from consultant accounts 304. The unequal level of permissions, or relationships, may enable consultant accounts 304 to receive more work targeted to their strengths.

A silo account 306 may provide yet another type of account on a tiered social network. The silo account 306 may be granted a very high level of permission to a selected cross-section of a social network. For example, the silo account 306 may receive administrator like permission to see other accounts on the network. In one embodiment, the limitations on a silo account include only a limit on the accounts over whom the silo account 306 has such extensive permissions.

In one embodiment, the silo account 306 is given extensive permissions over a silo or group, defined by a specific detail or property. For example, a silo account 306 may be granted administrator like access to all consultant accounts 304 that list a specific company as their current employer. For example, a consulting firm may be granted a silo account 306 that includes administrator like access to consultant accounts 304 of all employees of the consulting firm. In one embodiment, an entity may approach an owner of the social network and request a silo account 306 that provides access to all accounts having a specified property. The specified property may include current employees, past employees, consulting expertise, or any other property that may be found in an account. In one embodiment, the larger the group that has a specified property the larger a fee an owner of a social network may charge for creation of a silo account 306.

In one embodiment, a silo account 306 may be created for use by an individual or entity that employs or manages a plurality of other individuals or entities. For example, a silo account 306 may be provided to an organization that has a large number of its employees or members on a social network. According to one embodiment, the silo account 306 has privileges similar to the administrator account 300 but only with respect to accounts within a silo related to the silo account 306. For example, if a consulting firm employs one or more individual consultants, a silo account 306 may be created for the consulting firm and consultant accounts 304 may be placed in a silo connected to the silo account 306. The silo account 306 may then be able to view each of the contained consultant accounts 304 and any information entered into a profile. Some embodiments may include customer accounts 302, consultant accounts 304, silo accounts 306, or a combination of account types within a silo.

In one embodiment, an account that falls within a silo of a silo account 306 may receive a notification that it is subject to a silo. In one embodiment, one or more symbols may be displayed when a user is accessing an account to notify the user that the account details are visible to one or more silo accounts.

In one embodiment, some details within an account or details entered and/or stored within an account may not be visible to silo accounts. For example, job applications by a consultant account 304 may not be visible to a silo account 306. This may allow users of consultant accounts 304 to continue networking and looking for work without possible negative repercussions from an owner of a silo account.

As used herein the term silo is given to mean a grouping of users or grouping of accounts. According to one embodiment, the grouping of user's in a silo is based on membership in an organization such as a company, partnership, corporation, or other legally recognized entity. For example, a silo account 306 owned by a corporation may correspond to a silo that contains one or more employees or shareholders. In other embodiments, the grouping of user's in a silo may be based on any factor such as type of work or any arbitrary factor.

A silo account 306 may or may not be visible to other accounts or may only be visible to certain account types. According to one embodiment, a silo account 306 is visible to other accounts as a customer account 302 type and/or a consultant account 304. Thus, other accounts may interact with a silo account 306 as if it were one of a customer account 302, a consultant account 304, or both. For example, a customer account 302 needing services may be led to a silo account 306 if it meets the needed requirements and/or attributes.

In one embodiment, a silo account 306 may include all the total attributes of its member accounts. For example, if a silo account 306 provides access to a silo including all employees of a company, the silo account 306 may be reflected as having all the work experience within the accounts of the employees. In one embodiment, a user of the social network (such as a user of a customer account 302) may be able to search for a consultant having a specified work experience or skill set. The results of the search may return individual consultant accounts 304 as well as silo accounts 306.

In one embodiment, a silo account 306 or access equivalent to access provided to a silo account may be granted to another type of account. For example, silo account access may be granted to a consultant account 304 and/or a customer account 302. In one embodiment, various limitations on an account may still exist. For example, if silo account 306 access is incorporated into a consultant account 304, the consultant account may still be unable to see unconnected customer accounts 302.

Turning now to FIG. 4 a schematic diagram 400 illustrating exemplary visibility between the accounts types 300-304 is shown. Arrows on a plurality of lines are shown to illustrate what type of account can see another type of account. Specifically, the line between the customer accounts 302 includes arrows pointing both ways. This indicates that customer accounts 302 are visible to other customer accounts 302. Similarly, the lines between the consultant accounts 304 include arrows pointing both ways. However, the lines between the customer accounts 302 and the consultant accounts 304 only include arrows pointing in the direction of the consultant accounts 304. This indicates that the customer accounts 302 can see unconnected consultant accounts 304 but the consultant accounts 304 cannot see the unconnected customer accounts 302. With regard to the administrator account 300 the line with an arrow pointing towards box 402 indicates that the administrator can see all accounts within the box but the accounts (customer accounts 302 and consultant accounts 304) cannot see the administrator account 300.

In the depicted embodiment, the customer accounts 302 are visible to other customer accounts 302. However, in another embodiment, customer accounts 302 are not visible to other unconnected customer accounts 302.

The lines and arrows may also indicate how communications or connections between different account types may be initiated, according to one embodiment. For example, a customer account 302 may be able to send a message to a consultant account 304 which may then be able to reply to that message. In another example, a customer account 302 may be able to request the formation of a connection to a consultant account 304. After a connection is formed, the consultant account 304 may be able to see and/or initiate communication with the customer account 302.

It is important to note that although FIG. 4 illustrates exemplary visibility between administrator accounts 300, customer accounts 302, and consultant accounts 304, the account types are exemplary only. Any type of account may be substituted for one or more of the accounts 300-304 in varying embodiments.

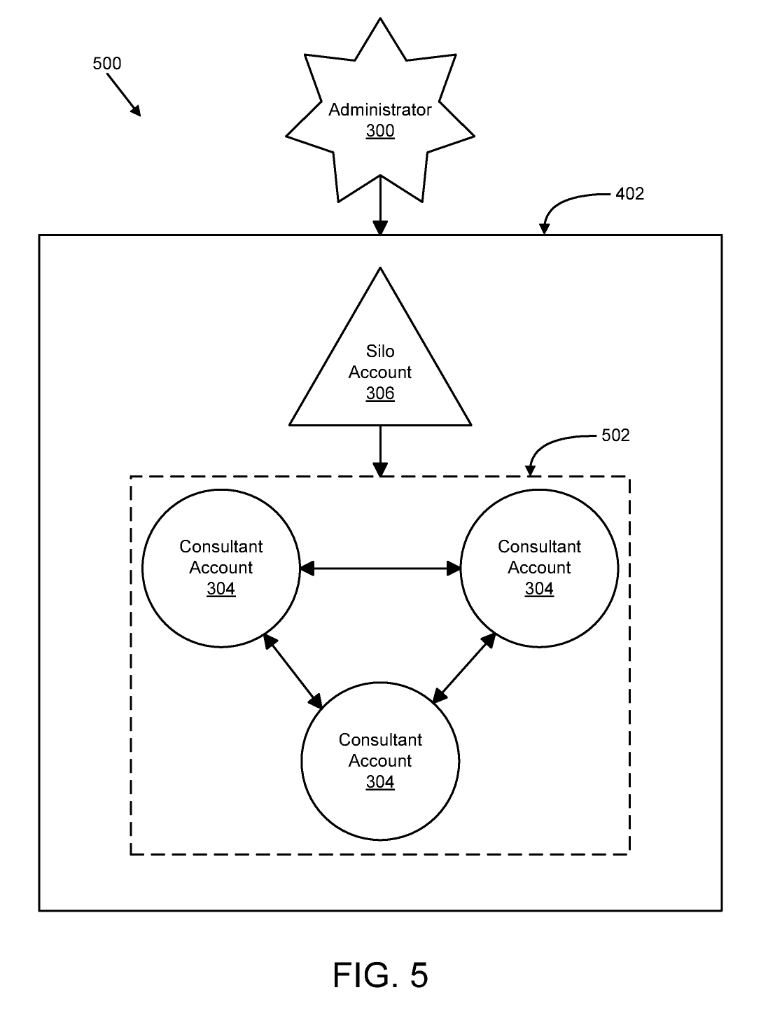

FIG. 5 is a schematic diagram 500 illustrating a silo account 306 and a silo 502 containing a number of consultant accounts 304. The silo account 306 is able to see all the consultant accounts 304 in the silo 502. According to one embodiment, the silo account 306 is able to see all details or almost all details stored in the profiles of the accounts in the silo 502. According to some embodiments, a silo 502 may contain other silo accounts 306 and silos 502. This may be useful to reflect the structure of an organization such as the departments within a corporation. In one embodiment, a symbol or notification may be displayed within the consultant accounts 304 within the silo 502 to notify users that they are visible to the silo account 306.

The silo 502 may allow a social network to be used as a workflow and networking tool internal to a company as well as external to a company. Many corporations spend large amount of money on developing software, creating and managing workflow methods, and/or providing infrastructure to keep employees busy and or finding the best individual for particular tasks. The silo 502 and associated silo account 306 may allow such a company or organization to utilize the structure, software, and resources of a social network to manage internal activities. This may bring down costs significantly and/or enable companies to better manage workflow.

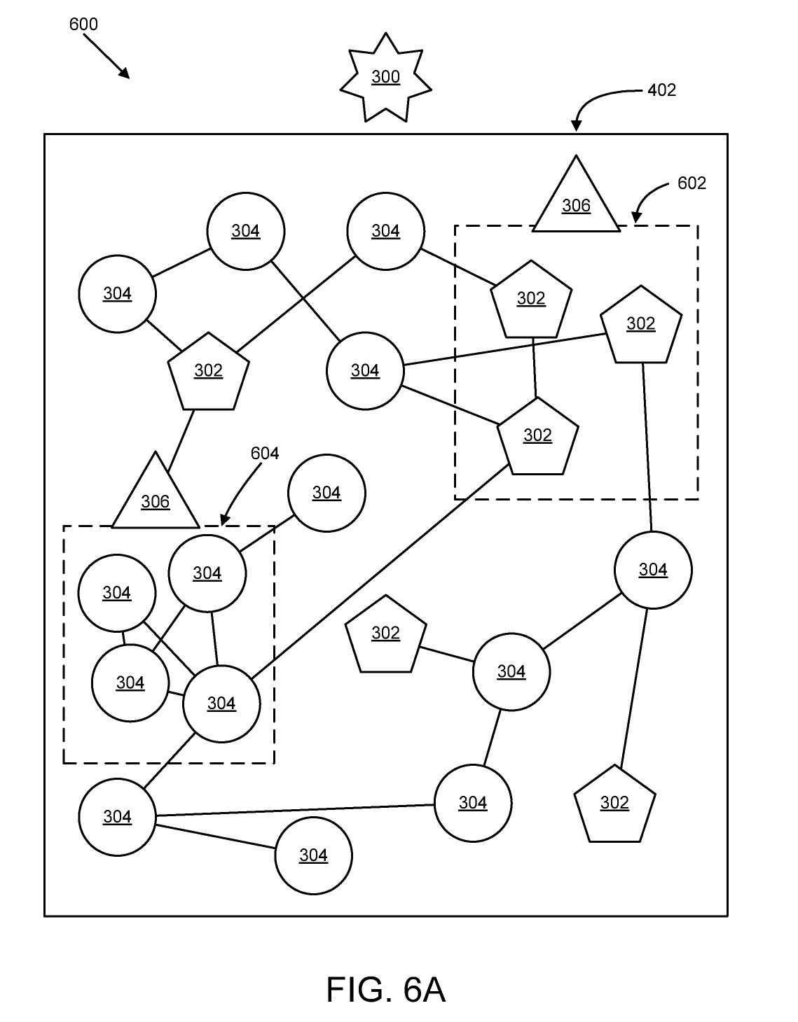

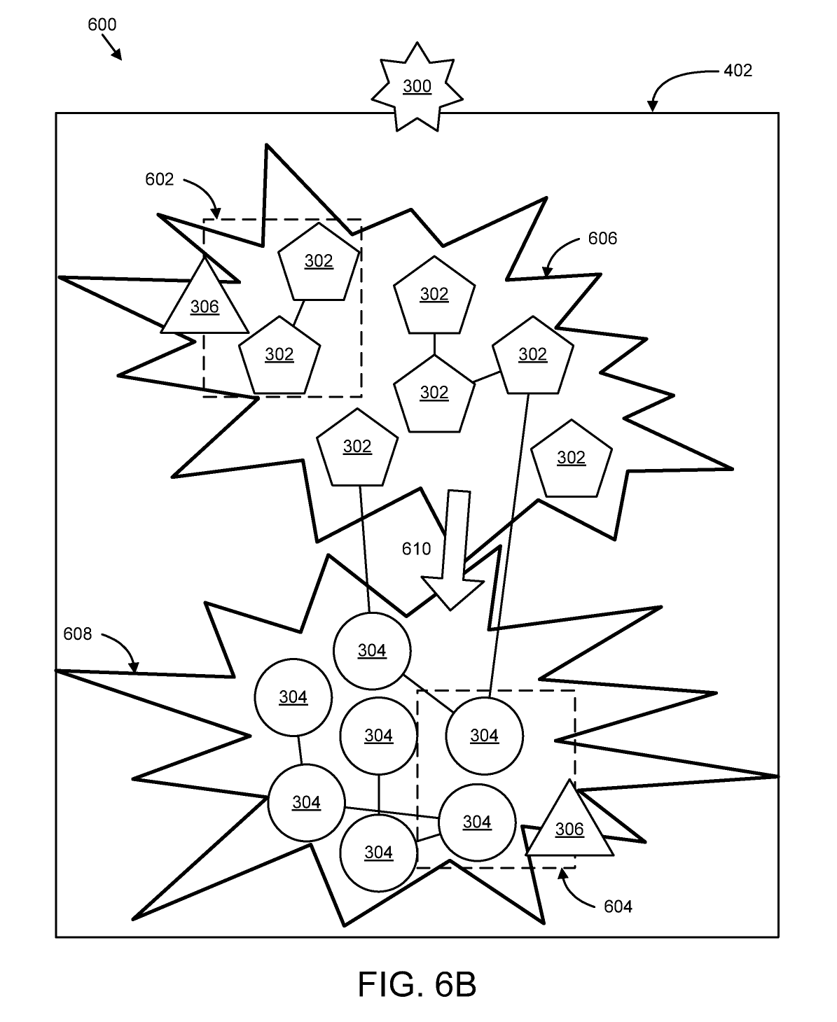

Turning now to FIG. 6A a schematic diagram illustrating an exemplary social network 600 and connections that have been formed between accounts is shown. The social network, except for the administrator account 300, is contained within box 402. Within the box 402 is a plurality of accounts 302, 304, 306, and silos 602, 604 and connections between the accounts (indicated by lines between the accounts).

A connection between accounts may indicate that the accounts 302, 304 or the individuals or entities corresponding to the accounts 302, 304 have had some interaction. For example, perhaps an individual corresponding to a consultant account 304 has provided consulting services for an entity corresponding to a customer account 302. It is important to understand that the connections indicated in FIG. 6 are different from the visibility lines shown in FIGS. 4 and 5. For example, in the social network 600 a customer account 302 may be able to see all other customer accounts 302 and consultant accounts 304 but only have connections to a handful of other accounts.

According to one embodiment, an account is able to see all other accounts with which it has a connection, regardless of account type. For example, if a consultant account 304 has a connection to a customer account 302, the consultant account 304 may be able to see the connected customer account 302. This may be the case even though customer accounts 302 are generally not visible to consultant accounts 304. In one embodiment, an account may be able to see most or all details of a profile of a connected account.

In one embodiment, the administrator account 300 is able to see all the accounts 302, 304 306, silos 602, 604 and connections between the accounts (indicated by lines between the accounts). The administrator 300 may also be able to see details stored in the profiles of the accounts 302, 304, 306 within box 402. According to one embodiment, the social network 600 also allows a user of an account 302, 304, 306 who has not been able to locate another customer or consulting provider to submit a request for assistance. In one embodiment, this request for assistance may be provided to the administrator account 300 which may then search the social network 600. Due to the greater access of the administrator account 300 it may be possible to locate a needed customer or consulting provider. Thus, the administrator account 300 may allow the owner or provider of the social network 600 to act as a middle-man in connecting potential customers with service providers. In one embodiment, a request for assistance is sent to a silo account which can then look to other accounts within a silo corresponding to the silo account to locate a needed customer or consulting provider.

Also shown in the social network 600 are two silo accounts 306 each associated with a silo 602, 604. The silo accounts 306, in one embodiment, may have rights similar to the administrator 300 in relation to the accounts within the silos 602, 604. For example, the silo account 306 connected to the silo 604 may be able to see all or almost all details stored in the accounts 304 within the silo 604. The silo account 306 may then be used to locate individuals that would be best for certain projects. In one embodiment, the silo 604 may correspond to an engineering firm and the consultant accounts 304 correspond to engineers within the engineering firm. The silo account 306 may then be used by the engineering firm to locate one or more engineers for a project based on what is in the user profiles of their corresponding consultant accounts 304. In this manner, the social network becomes not only a job seeking and networking tool external to companies but also a workflow tool internal to companies.

As previously mentioned the silo accounts 306 may or may not be visible to other accounts 302, 304 in various embodiments. In some embodiments, the silo accounts 306 may appear to other accounts as a consultant account 304 or a customer account 302 based on the type of accounts contained in its corresponding silo 602, 604. For example, the silo account 306 connected to the silo 602 may appear to be a customer account 302 to other accounts and the silo account 306 connected to the silo 604 may appear to be a consultant account 304 to other accounts. In one embodiment, a silo may contain both customer accounts 302 and consultant accounts 304 and a corresponding silo account 306 may appear to have both consulting and customer properties to other accounts.

The social network 600 illustrates one embodiment of a multi-tiered social network. The different types of accounts 300-306 as well as the silos 602, 604 provide a significant level of functionality. The limited visibility of the customer accounts 302 to the consultant accounts 304 may allow for more efficient use of the social network 600. For example, users of customer accounts 302 may not want repeated solicitations for work. The ability for the customer accounts 302 to see consultant accounts 304 may allow them to search and locate the best consultant for their particular needs. With regard to the consultant accounts 304 being visible to all the customer accounts 302 may be quite desirable. Numerous customers may have the ability to easily search for and locate a consultant. Thus, a consultant may be able to concentrate more fully on providing consulting services rather than advertising and seeking for additional consulting work.

Turning to FIG. 6B an exemplary configuration of a social network 600 that includes a first social network 606 and a second social network 608. The social network 600 is similar to the social network 600 of FIG. 6A in that it includes a number of accounts 300, 302, 304, 306, and silos 602, 604 as well as relationships (represented as lines) between accounts. Thus, any of the teachings and variations discussed in relation to FIG. 6A may also be applicable in the social network 600 of FIG. 6B.

In addition to the similarities with FIG. 6A, FIG. 6B also illustrates a number of differences. For example, the accounts 302, 304, and 306 are separated into two different sub-networks, a first social network 606 and second social network 608. According to one embodiment, the sub-networks 606, 608 may operate as fully functional social networks. In one embodiment, the sub-networks 606, 608 may be networks that previously operated independently, and have been combined through functional relations between the networks. In one embodiment, accounts within the same network may be equal in relation to permission while the accounts in different networks 606, 608 may be unequal. Arrow 610 illustrates exemplary inequality between the networks 606, 608. According to one embodiment, the accounts of the first network 606 may have greater permissions with regard to the accounts of the second network 608 than the accounts of the second network 608 have in relation to the accounts of the first network 606.

According to the depicted embodiment, the first network 606 is a social network for customers, or customer accounts 302 while the second network 608 is a social network for consultants, or consultant accounts 304. The customer accounts 302 and consultant accounts 304 may have the same or similar functionality as discussed in relation to previous figures.

The embodiments of FIGS. 6A and 6B reflect exemplary structures and construction of social networks in accordance with the present invention. In one embodiment, the sub-networks 606, 608 may reflect a data structure of the social network 600. According to one embodiment, all of the accounts 300-306 of the social network 600 may be stored within a single database. In another embodiment, two or more databases may store the accounts 300-306. In one embodiment, the accounts 302, 306 of the first network 606 are stored and managed by a first database and the accounts 304, 306 of the second network 608 are stored and managed by a second database.

In one embodiment, the permission between accounts of different types (such as permission between accounts 302 and 304) may be defined by permissions between the first network 606 and the second network 608 as indicated by arrow 610. In one embodiment, the permissions between accounts may be defined in relation to the accounts themselves and not the sub-networks. One of skill in the art in light of the present disclosure will recognize that the varying of permissions between may be accomplished in a variety of manners though any combination of account types, sub-networks, databases, and permission.

Additional advantages will also be discussed and/or become apparent in relation to further discussion and the remaining figures.

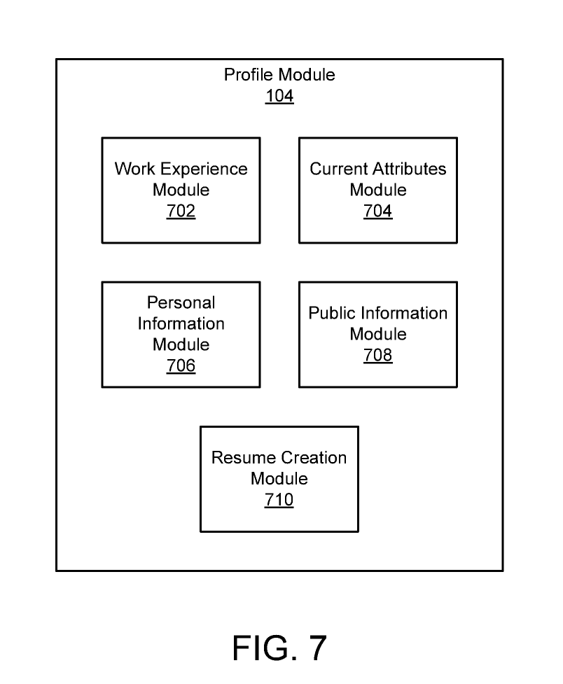

FIG. 7 is a schematic block diagram depicting an exemplary profile module 104 according to one embodiment. The profile module includes a work experience module 702, a current attributes module 704, a personal information module 706, a public information module 708, and a resume creation module 710. It should be understood that while the profile module 104 and its functionality is discussed in relation to the multi-tiered network of FIGS. 3-6B, the same functionality may also be applicable as improvements on non-tiered social networks.

The profile module 104 provides and manages a profile for an account, such as accounts 300-306, which can be filled in and/or modified by a corresponding user. The profile module 104 may require a user to provide at least certain details for a profile before a corresponding account becomes visible to others and/or before the account becomes functional for networking purposes.

According to one embodiment, the details or information that may be entered into a profile may vary with the account type. In one embodiment, the consultant account 304 of FIGS. 3-6B may include a profile that is configured to receive details desirable for a consultant account. For example, the profile may be configured to show work experience, availability, and or other information that may be useful to a consultant or to those searching for a consultant. In one embodiment, the customer accounts 302 of FIG. 3-6b may include a profile that is configured to receive details desirable for a customer account. For example, the customer account 302 profile may be very limited and only include general information such as the name of a corresponding customer, such as an individual or entity.

The work experience module 702 collects work experience data for storage in a profile. According to one embodiment, the work experience module 702 collects and displays work experience data in a stratified manner. According to one embodiment, collecting work experience data in a stratified manner involve collecting information about work experience at two or more abstracted layers. For example, the work experience module 702 may allow a user to enter work experience details corresponding to a high level of abstraction regarding work experience and also allow a user to enter work experience details corresponding to a more specific level regarding work experience.

For example, a first abstracted layer may correspond to a type of industry served. A user may be prompted to select the types of industries the user has served and then provide the total number of years worked serving those industries. A second abstracted layer may correspond to a category of service. A third abstracted layer may to specific consulting services offered.

Often, work experience is listed in a chronological view. This manner of presenting work experience often fails to communicate a job candidate's skills or experiences in a specific area. Often, employers are looking for an individual with a certain amount of experience in a specific industry or category. Displaying work experience by employment position and/or chronologically generally fails to convey this information. Additionally, even if this information is decipherable it often requires extra time by a reviewer.

By presenting job experience in a stratified manner an employer and/or job reviewer can quickly ascertain what the individuals expertise is and how well it corresponds to a project or employment position. In other words, that data is presented in the same manner that employers generally think when searching for job candidates. Additionally, gathering, storing, and/or displaying work experience in a stratified manner enhances how well work experience can be searched. This can have significant positive impact on the ability to find the right consultant in a large social network.

According to one embodiment, the access to the features provided by the profile module 104 may depend upon permissions of an account. According to one embodiment, accounts of a first type may not be allowed to access one or more portions of a profile unless they are connected to an account that corresponds to the profile. In one embodiment, an administrator type account, a silo type account, or other type of account may be granted access to portions of a profile that are not accessible to other accounts.

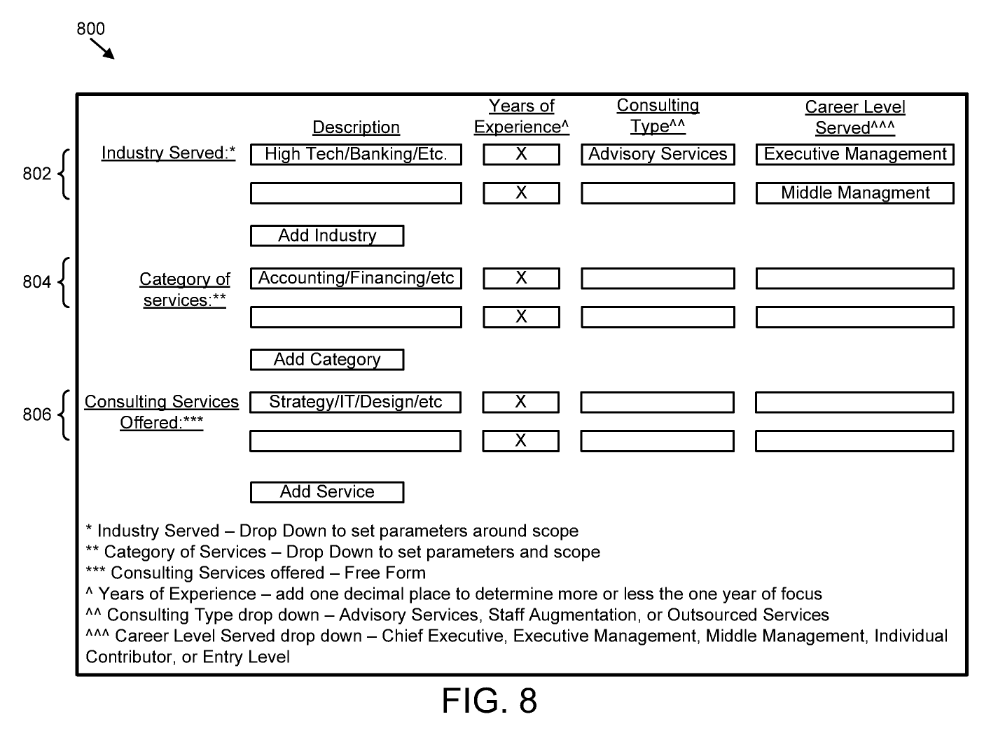

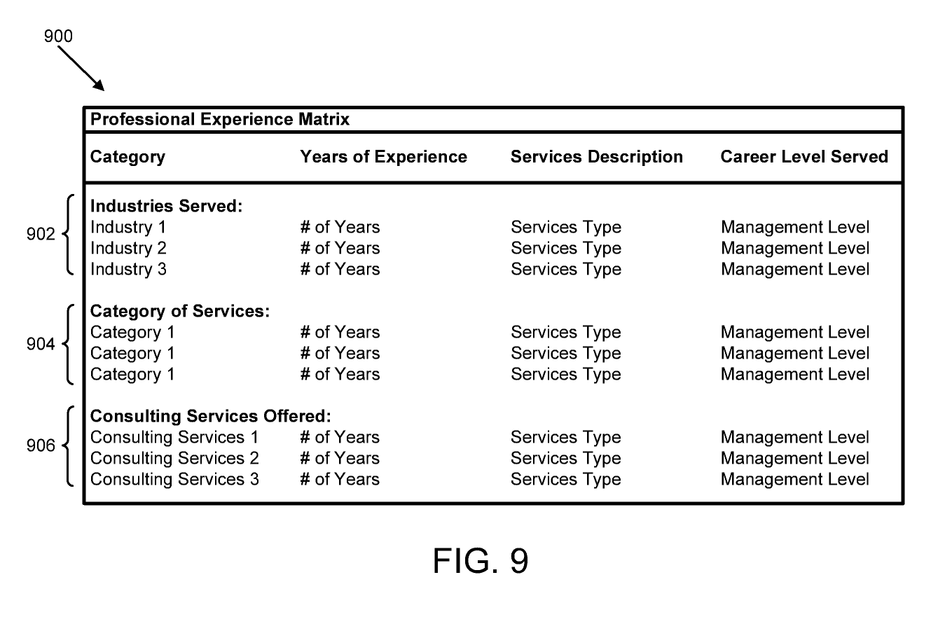

FIGS. 8 and 9 depict exemplary entry and display of work experience provided by the work experience module 702. FIG. 8 shows an exemplary portion of a webpage 800 allowing for stratified entry of professional experience. The webpage 800 allows for three abstracted layers. Other embodiments may include fewer or additional abstracted layers. In the depicted first layer 802 a user can enter information regarding the industries the user has served. In the second depicted layer 804 a user can enter information regarding the category of services provided. In one embodiment, the category of services may include one or more functional areas within an industry, such as an industry selected or entered in the first layer 802. In the third layer 806 a user can enter information corresponding to the consulting services offered.

According to the depicted embodiment, each of the layers 802-806 includes a plurality of columns that include fields where information may be selected or entered regarding that layer. According to the depicted webpage 800 the user can enter a description, the years of experience, the consulting type, and the career level served in corresponding columns. Other fields may also be available in various embodiments. According to one embodiment, the webpage 800 allows entry using drop down list boxes, and/or simple text entry. According to one embodiment, after data has been entered on the webpage 800 the data is stored in a data store for later access.

According to one embodiment, the first layer 802 includes a drop down box that includes a variety of industries. According to one embodiment, exemplary industries listed in the drop box may include, but are not limited to one or more of the following: Accounting—Audit Services; Advertising—Marketing/Public Relations; Aerospace—Defense; Agriculture; Architectural and Design Services; Art—Photography; Automotive; Aviation—Airline; Banking—Financial Services; Biotechnology; Business Services; Chemical; Computer—Hardware/Software/Services; Construction; Consumer Products; Education—Academics; Electronics—Semiconductors; Employment—Recruiting/Staffing; Energy—Utilities/Fuel; Engineering Services; Entertainment; Environmental—Green Services; Exercise and Fitness; Fashion—Apparel; Film—Perfoming Arts; Food and Beverage; Funeral—Cemetary; Government—Civil Services; Government—Military Services; Healthcare; Hospitality; Import—Export; Industrial; Insurance; Internet Services; Law Enforcement; Legal Services; Library Science; Management; Consulting Services; Manufacturing; Media—Broadcasting/Journalism; Merchandising; Metals and Minerals; Music; Nonprofit/Charitable Organization; Office Supplies—Equipment; Personal and Household Services; Pharmaceuticals; Real Estate—Sales/Lease/Management; Rental Services; Restaurant—Food Services; Retail; Security and Surveillance; Social Services; Sports and Physical Recreation; Staffing and Employment; Telecommunications—Wireless Services; Training; Transport and Storage; Transportation; Travel—Tourism; Waste Management; Wholesale.

According to one embodiment, the second layer 804 includes a drop down box that includes a variety of service categories, or functional areas within an industry. According to one embodiment, exemplary categories or functional areas listed in the drop box may include, but are not limited to, one or more of the following: Accounting; Administrative—Clerical; Business/Strategic Management; Customer Support; Education—Training; Engineering—Science/R&D; Executive Management; Finance; Food Services—Hospitality; Human Resources; IT Services—Systems Administration; Legal; Logistics; Maintenance; Marketing—Advertising/Sales; Operations—Manufacturing/Production; Procurement/Contract Administration; Product Development; Program/Project Management; Quality Assurance; Real Estate; Safety; Security—Loss Prevention. As will be understood by one of skill in the art in light of the present disclosure, the above lists are exemplary only. Additional or alternate industries, categories, or functional areas may be listed in some embodiments.

FIG. 9 depicts an exemplary stratified view of work experience in a professional experience matrix 900. According to one embodiment, the work experience module 702 pulls data from a data store to create the professional experience matrix 900. The professional experience matrix 900 includes a first level of abstraction 902, a second level of abstraction 904, and a third level of abstraction 906.

Returning to FIG. 7 the current attributes module 704 allows a user to enter data corresponding to attributes of the user to be available for others to see. The current attributes module 704 collects answers to a variety of questions which may be quite useful to employers and job seekers. The answers to the questions may be made publicly available on the user's profile, such on a dashboard page of the profile, where customers can view the answers to determine whether the consulting individual or entity meets the customer's requirements.

The questions asked can vary greatly. According to one embodiment the questions asked are directed towards location, availability, travel considerations, and/or consulting types, preferred team size. These may often be questions that require a proper answer before employment is even considered. This may be very helpful since employers may spend considerable time finding an individual that meets their needs only to find that the individual refuses to go to a certain location or is not currently available.

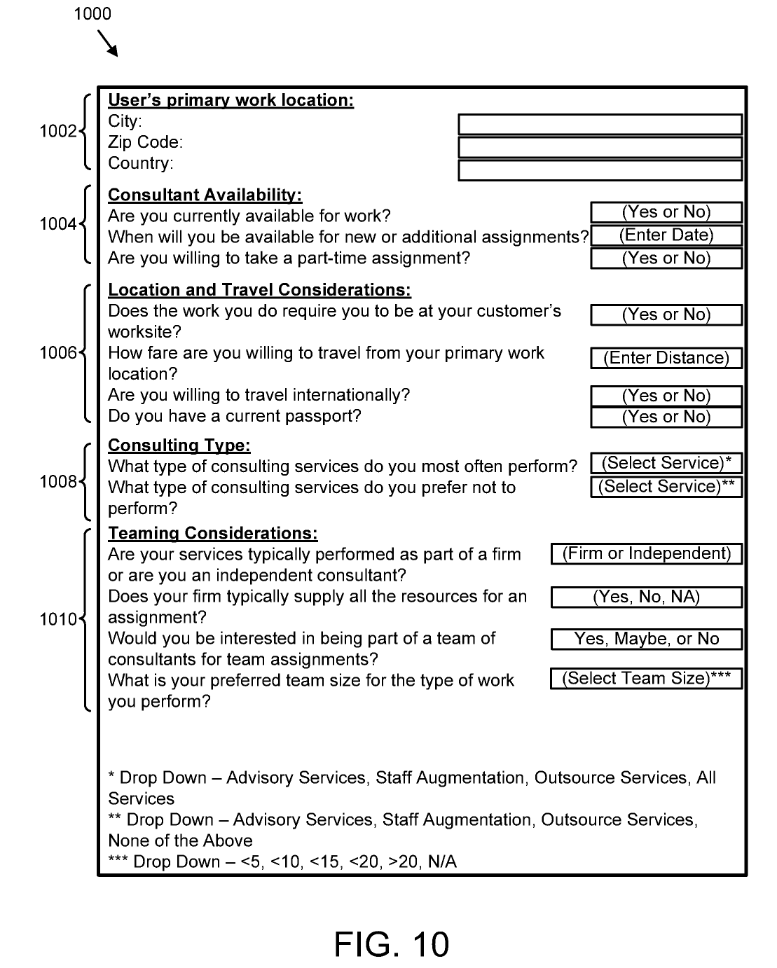

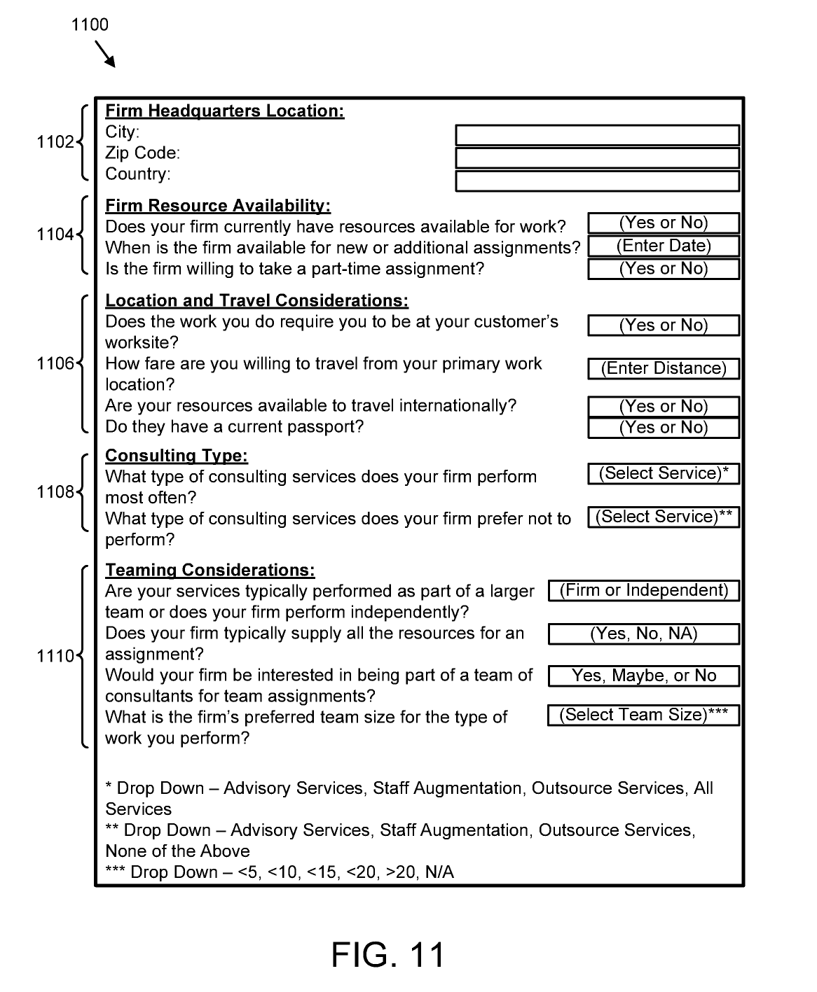

FIGS. 10 and 11 depict exemplary pages 1000 and 1100 illustrating exemplary dashboard attribute questions and entry. FIG. 10 shows a webpage 1000 illustrating exemplary layout and questions to be answered by an individual consultant. A location section 1002 collections information about the individual's work location

An availability section 1004 collects information about the individual's availability to work. A travel considerations section 1006 collections information about the individuals traveling ability and desires. A consulting type section 1008 collects information about the type of consulting an individual generally performs and prefers not to perform. A teaming section 1010 collects information regarding the individual's teaming desires and abilities.

FIG. 11 shows a webpage 1100 illustrating exemplary layout and questions to be answered by a consulting firm or entity. A location section 1102 collections information about the firm's work location. An availability section 1104 collects information about the firm's availability to work. A travel considerations section 1106 collections information about the firm's traveling ability and desires. A consulting type section 1108 collects information about the type of consulting a firm generally performs and prefers not to perform. A teaming section 1110 collects information regarding the firm's teaming desires and abilities.

As will be understood by one of skill in the art in light of the present disclosure, the above sections 1002-1010 and 1102-1110 and the included questions are exemplary only. Fewer, additional, or alternate questions may be provided in other embodiments. According to one embodiment, an additional credibility section may also be included which may allow a user to request a third party to review and verify the accuracy of at least a portion of information entered in the user's profile. According to one embodiment, the third party would review one or more of the work experience of the user, the dashboard attributes of the user, a detailed resume, or other type of information provided in the profile.

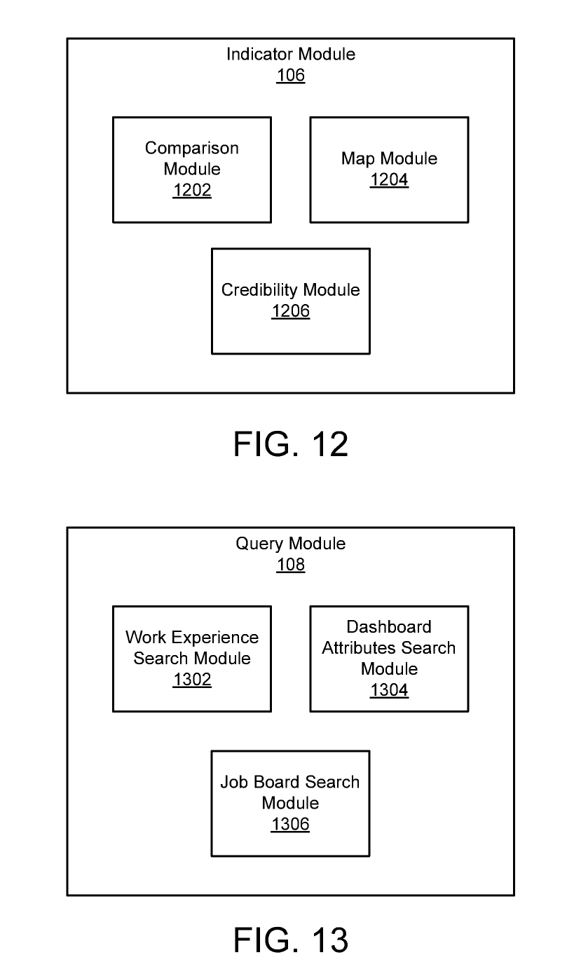

A reviewer may review the details of the profile in a variety of manners. According to one embodiment, a reviewer may do a background check on the individual by contacting references, previous employers, or even performing a criminal background check. The reviewer may meet an individual or officer of an entity to verify identity, resources, and the like. This may provide trust for customers and potential clients to know that a third party has investigated a service provider and or consultant. Credibility or verification procedures may be performed in manners discussed in relation to the credibility module 1206 of FIG. 12, in one embodiment.

Returning once gain to FIG. 7, the personal information module 706 may allow a user to enter, update, and store personal information in the account profile. According to one embodiment, the personal information module 706 maintains this personal information in confidentiality and does not allow it to be seen by other accounts. According to one embodiment, this information is not even available for viewing by the administrator account 300. In addition to entered personal information, the personal information module 706 may store communications, such as emails or other communications sent within a social network, as confidential. An account's connections may also be kept confidential.

The public information module 708 may allow a user to enter or update information that the user desire to be seen by others. This may include a professional introduction, a short history about the user or entity, or even the ability to enter and provide “tweets”, status messages, or other electronic postings or communications known in the art. According to one embodiment, the public information module 708 allows this information to be seen by any account. According to another embodiment, this information may only be seen by accounts to which the profile is visible. According to another embodiment, this information may be viewable on the internet even to those not having an account on the social network.

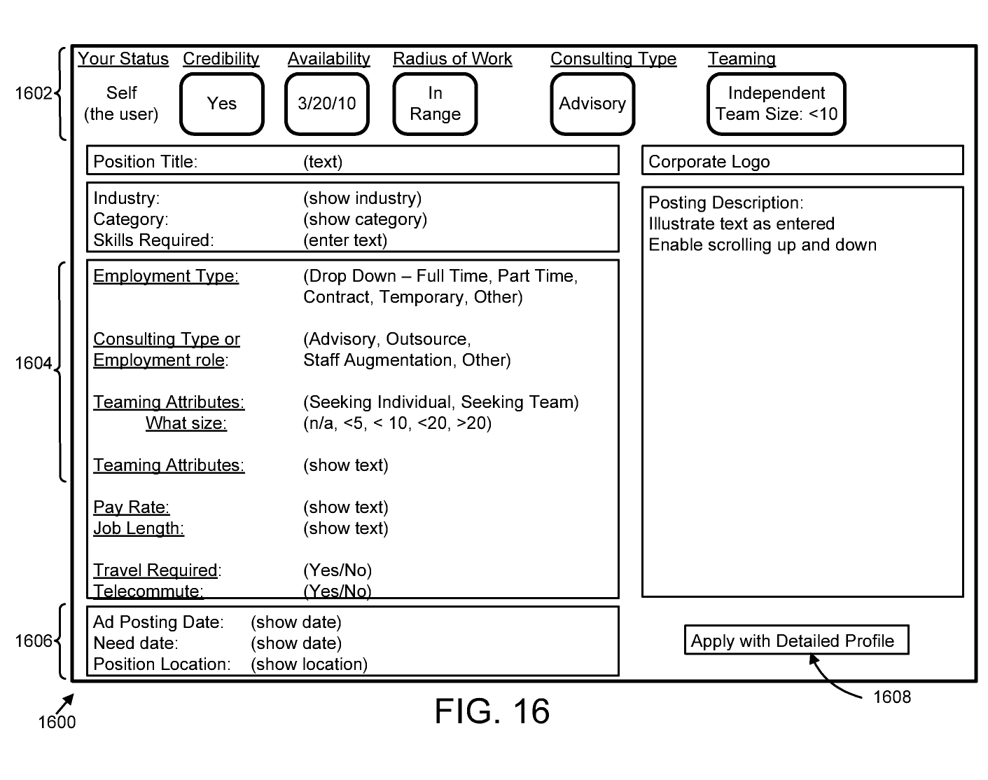

The resume creation module 710 creates at least a portion of a resume from the information entered by in a profile by a user. For example, the resume creation module 710 may collect and combine information obtained by the work experience module 702, the current attributes module 704, and/or other modules to provide create at least a portion of a resume. An exemplary resume assembled by the resume creation module 710 will be discussed in relation to FIG. 16.

The information in a profile provided by the profile module 104 may be made visible to other accounts based on a variety of factors. These factors may include one or more of preferences of the owner of the account, the type of account that is attempting to view a user's profile, the type of account on which the profile resides, and the section within the profile where information was entered. Other factors may also be used in controlling the visibility of information in a user profile.

FIG. 12 depicts a schematic block diagram of an indicator module 106 according to one exemplary embodiment. The indicator module 106 provides indicators that reflect the degree of matching or similarity between two sets of data. The indicator module 106, as depicted, includes a comparison module 1202, a map module 1204, and a credibility module 1206.

The comparison module 1202 compares two sets of data and provides an indicator reflecting the degree of match. According to one embodiment, the comparison module 1202 receives two sets of availability data, such as availability requirements for a job or query and the dashboard attributes and/or work experience of a particular consultant. The comparison module 1202 then compares the job requirement or query with the attributes of a consultant. Depending on the degree of match, different indicators may be provided. The indicators may include a number, a color, a word, a graph, a graphic, or some combination these. For example, an indicator reflecting a good match may be green while an indicator reflecting a bad match may be red. Some embodiments may include additional levels of indicators. For example, going along with the previous examples, a yellow indicator may reflect that the match is a fairly close match but not an exact match.

Instead of using colors, other indicators may include numbers, such as percents to indicate a match. Other indicators may include words such as good, bad, close, etc. Other indicators may include graphics such as circles, X's, smiles, frowns, etc. Yet other indicators may include a combination of the above.

The indicators provided by the comparison module 1202 may enable a job applicant or employer to quickly ascertain how good of a match a candidate is for a job. An employer or application reviewer may not need to dig through a job application to find the most important details or attributes of an applicant. Rather, the employer can quickly see that important qualifications or attributes are present or absent. If the qualifications or attributes are absent, the employer can quickly discard the application and move to the next one. If the qualifications are present, the employer can look more closely at the application and/or set up an interview or appointment to meet with the candidate.

The map module 1204 displays a map to illustrate the location of different work locations and/or traveling regions. The map module 1204 may be used in relation to location attributes or requirements as well as traveling attributes or requirements. For example, a job applicant may be able to look at a map to decide whether a job opportunity is within range of is traveling abilities. Alternately an employer can look at the map to see if a potential consultant would be available in a particular location or region.

The credibility module 1206 may provide an indicator showing whether a third party has verified information in the profile of an account. According to one embodiment, the credibility module 1206 may return a range of indicators depending on whether the account has been verified, whether a verification procedure revealed inaccuracies or problems, and/or whether no verification process has been undertaken.

The indicator module 1206 may be able to look up information resulting from a verification procedure and return a credibility indicator reflecting the verified credibility of the account.

According to one embodiment, a person's or entity's identity may be verified to determine the account user's level of credibility. In one embodiment, the level of credibility may be evaluated before the individual or entity is allowed to create an account.

In one embodiment, an account may be created prior to verification but various features may be disabled until a person's or entity's identity is verified. In one embodiment, one or more details besides identity may be verified prior to account creation or enablement of features. For example, a background check, employment verification, employment history verification, or other details with regard to an individual or entity may be verified. The identity or details may be verified by an owner of a social network or by some other third party.

In one embodiment, having a third party perform an evaluation of an individual on the social network may allow for significant level of trust. For example, if an account simple endorsements from other accounts or individuals on the social network may not be as trustworthy because the credibility of the endorsing account may not be verifiable. Thus, you may have two unknowns endorsing each other with no real way of verifying that the individuals or entities are who they say they are. Third party verification by the owner of the social network or some other entity may help customers or those seeking goods or services to receive have trust that the details of a profile or job application are accurate.

FIG. 13 depicts a schematic block diagram of a query module 108 according to one exemplary embodiment. The query module 108 may provide search features to accounts allowing them to locate other individuals, entities, or job postings. According to one embodiment, the search features available to different account types may vary. The query module 108, as depicted, includes a work experience search module 1302, a dashboard attributes search module 1304, and a job board search module 1306.

The work experience search module 1302 allows a user to perform a search for accounts having desired work experience. According to one embodiment, the work experience search module 1302 searches for entries in their professional experience matrices 900 on their profiles. This may allow a user to go searching for a firm or individual consultant that can meet its consulting needs rather than posting a job and receiving a large number of applicants to dig through.

Searches may be performed according to a variety of methods. According to one embodiment, a text search may be performed which searches for a provided text entry. This may be similar to web searches well known in the art. According to another embodiment, a variety of drop down boxes are provided that correspond to drop down boxes in a professional experience matrix entry form 800. Results may be returned that include accounts that selected the same item from a drop down box, or the same combination of items from drop down boxes.

Yet another method of searching may include the browsing of a professional experience tree. This may be enabled in part by the professional experience matrix 900. A user could browse a first abstracted layer to select, for example, a desired industry served. The user could then dig deeper by browsing and selecting a category from a second abstracted layer. The user could continue through the professional experience tree until the user has located the desired area and one or more profiles of corresponding accounts have been provided. According to varying embodiments, this search may be performed with drop down and or multiple choice boxes, text searches, or browsing of a graphical tree structure.

According to one embodiment, using the work experience search module 1302 may be restricted. For example, in one embodiment only the administrator account 300 can perform work experience searches. In other embodiments, only certain account types can perform such searches. In another embodiment, silo accounts 306 may also be able to perform such searches, but only in respect to those accounts in a corresponding silo. In one embodiment, an additional account type granting access to search features of the work experience search module 1302 may exist. For example, an individual or entity may not desire to create an account of one of the existing account types but may simply wish to search the social network for individuals or entities that can provide specialized services. This individual may be able to perform the search and use this information to contact a specific individual or entity without going through the process of posting a job on a job board. According to another embodiment, work experience searches can be made available based on payment for time, payment per search, or payment per profile accessed. For example, an account may be allowed to search on a per-search fee basis, per-time fee basis, processor workload fee basis, or any other fee basis known in the art.

The dashboard attributes search module 1304 allows a search based on dashboard attributes, such as those discussed in relation to FIGS. 7, 10, and 11. Such searches may also be restricted in a manner similar to that described in relation to the work experience search module 1302. According to one embodiment, customer account 302 can perform searches based on dashboard attributes to locate a consultant account 304. According to one embodiment, an administrator account 300 can perform attribute searches for the whole social network 600. According to one embodiment, a silo account 306 may be allowed to perform attribute searches for accounts in a corresponding silo. In one embodiment, an additional account type granting access to search dashboard attributes may be created. Additionally, fee-based searches may also be available for purchase by one or more account types. In one embodiment, any account may be used to perform an attribute search of other accounts with whom the account has connections.

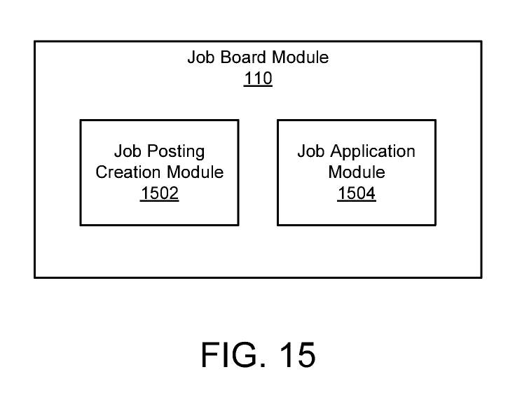

The job board search module 1306 may be used to search a job board for job postings that correspond to search requirements. For example, a consultant account 304 may be used to locate a job for the account user. As another example, a customer account 302 may be used to find competing job postings. Job boards will be covered with greater detail in relation to FIGS. 15-18.

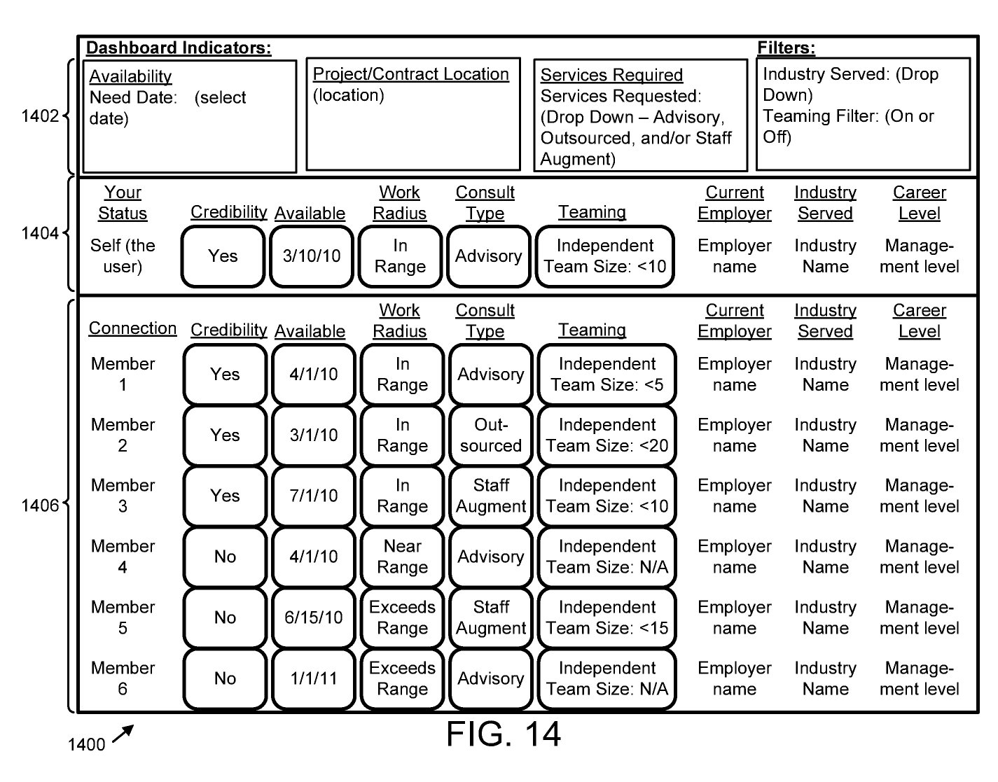

Turning now to FIG. 14 an exemplary web page view of a dashboard attribute search page 1400 containing indicators 1407 is shown. The dashboard attribute search page 1400 includes a search requirements section 1402, a user attributes match section 1404, and a search results section 1406.

The search requirements section 1402 includes a variety of search requirements that can be selected, entered, or changed. The search requirements section includes search requirements that correspond to the dashboard attributes shown in FIGS. 10 and 11. For example, the search requirements section 1402 includes requirements for availability, location, type of consulting services, etc. A user performing a search may select the options that correspond to a desired candidate and the user attributes match section 1404 and search results section 1406 may change to reflect the selected or entered search requirements.

The user attributes match section 1404 includes indicators 1407 that reflect the degree of match between the user's attributes (the account performing the search) and the search requirements selected in the search requirements section 1402. According to one embodiment, the indicators 1407 correspond to one or more dashboard attributes provided by a user. For example, the questions in the sections 1002-1010 and 1102-1110 of FIGS. 10 and 11 may have indicators corresponding to the questions and/or sections. Additional indicators for other attributes and/or qualifications of a user may also be present.

According to one embodiment, the indicators 1407 are of a color that indicates the degree of match between the search requirements and the user's attributes. In the depicted embodiment, the indicators 1407 include information indicating the user's attributes. For example, the first indicator in the user attributes match section 1404 includes the word “Yes” indicating that the answer to the “Credibility” question was yes. According to other embodiments, the indicators do not include information indicating the user's attributes, but rather only show the degree of match.

The search results section 1406 includes a plurality of accounts and corresponding indicators 1407. According to one embodiment the search results are arranged with better matches at the top and poorer matches towards the bottom.

The dashboard attribute search page 1400 is exemplary only, as will be understood by one skilled in the art in light of the present disclosure. Additionally, similar principles and layouts discussed in relation to FIG. 14 may be applicable to work experience searches, job board searches, etc. Additionally, rather than searching for individual consultants the dashboard attribute search page 1400 may also be used to search for consulting firms.

The query and search abilities provided by the query module 108 may provide significant benefits to a social network. For example, the ability for a consultant to be found by such a search may provide motivation for users to keep account details, such as profile information, current and accurate. Having work after a current project may be vital to staying employed and earning sufficient money for the consultant. Thus, for example, the consultant will be very motivated to update when he or she is available so that the next project will not be missed. Additionally, the filling out of work experience and other details would need to be done as accurately and completely as necessary to make sure work opportunities are not missed.

FIG. 15 depicts a schematic block diagram of a job board module 110 for providing a job board according to one exemplary embodiment. The job board facilitates the joining of those in need of services or goods with those providing services or goods. In the present embodiment, operation of the job board module 110 will be discussed in relation to assisting customers locate and employ consultants. The job board module 110 includes a job posting creation module 1502 and a job application module 1504.

The job posting creation module 1502 allows a user of an account, such as a customer account 302, to create a job posting by entering details regarding the job or project. For example, the user can select desirable dashboard attributes and/or work experience for applying individuals. According to one embodiment the user can also enter a brief description of the job or project, a short introduction to the potential employer etc. This job posting may then be available for others to view. According to one embodiment, a posted job is available only to a social network.

According to one embodiment, only certain types of users can view the job posting. For example, only consultant accounts 304 may be allowed to see job postings. In another example, silo accounts 306 are also allowed to see and apply for job postings. This may be, for example, on behalf of a silo connected to a silo account 306. According to another embodiment, only accounts that have one or more dashboard attributes and/or work experiences that meet the requirements for the job posting can view the job posting. Some embodiments may allow certain accounts to see, but not apply for job postings. For example, only accounts that have one or more dashboard attributes and/or work experiences that meet the requirements for the job posting may be able to apply for the job posting, although all may be able to see the job posting. Additionally or alternatively, customer accounts 302 may be able to see but not apply for job postings.

Jobs posted on the job board may be directed towards obtaining an individual consultant or a full team of consultants. According to one embodiment, a job posting may contain details and requirements needed for a consulting project and the number of individual consultants may be left open. Such a team job posting may allow a variety of individuals having one or more of the requirements in the job posting to apply and the customer can create a team meeting all the requirements for the job posting from the applicants. According to one embodiment, a group of individuals may apply to the job posting as a team. According to another embodiment, a firm may apply for a team job posting on the basis of the attributes and work experience of one or more of its members. In one embodiment, separate individuals or firms may apply for different aspects of the jobs. The job poster may then be able to select one or more applicants to act as a team in fulfillment of the requirements for the job. Thus, the job board module 110 may enable the obtaining of individuals, firms, or custom teams for the performing of a job.

The job application module 1504 provides a job posting page where potential job candidates can view the job posting. The job application module 1504 may provide details of the job posting including requirements and descriptions provided by the job poster. According to one embodiment, the displayed job posting page include indicators that show how well a potential applicant matches up with one or more of the job requirements. According to another embodiment, the job application module 1504 obtains data from a user profile when a user applies for a job posting to create a job application.

Turning now to FIG. 16 an exemplary web page view of a job posting 1600 is shown. The job posting 1600 includes an indicator section 1602, dashboard attributes sections 1604, 1606, and an application option 1608. A potential job applicant may view the job posting 1600 to determining how well he or she matches the job requirements, determining whether he or she is interested, and/or apply for the job posting.

The indicator section 1602 may be similar to the user attributes match section 1404 of FIG. 14. The indicator section 1602 includes one or more indicators 1407 which indicate the degree of match between one or more attributes of the potential job candidate and one or more job requirements for the job posting 1600. Thus, a user looking at the job posting 1600 can quickly determine whether the job posting is compatible with the user's dashboard attributes.

The dashboard attributes sections 1604, 1606 include one or more job requirements that correspond to one or more dashboard attributes. These may be the one or more requirements for the job posting 1600 that are used to produce the indicators 1407 of the indicator section 1602. The job posting 1600 also includes a variety of other sections where additional requirements, descriptions, and/or employer information may be shown. If after viewing the job posting 1600 a potential job candidate decides to apply for the position, the candidate can select the application option 1608 to begin the application process. The application process may include, among other things, a submission of a job application that includes a resume.

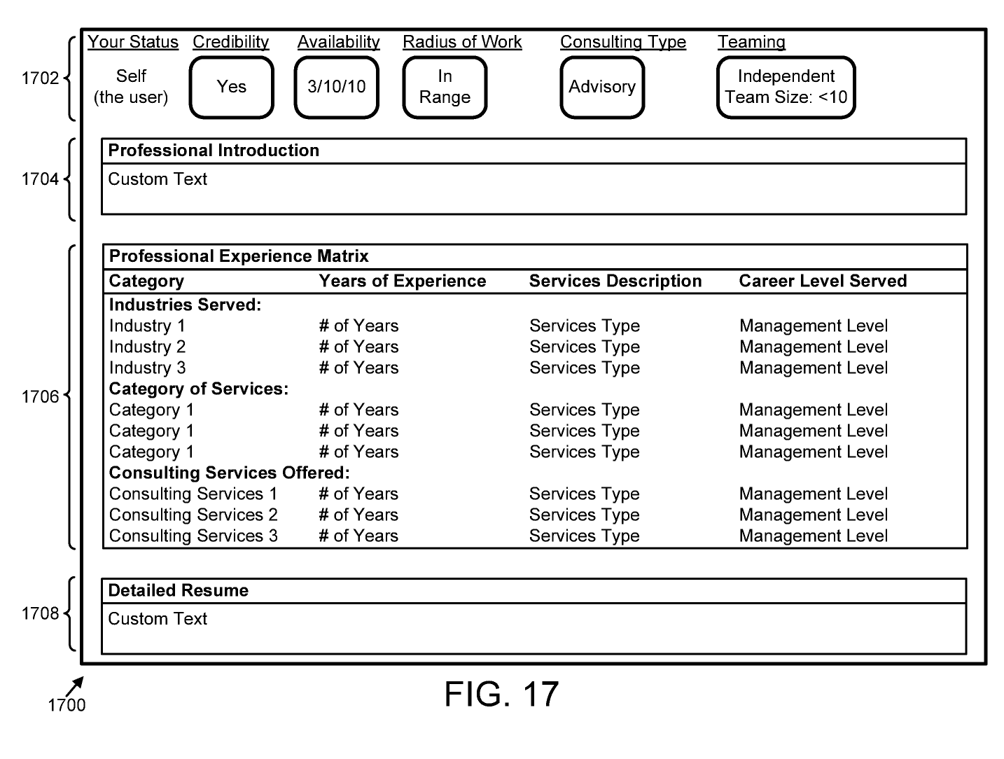

FIG. 17 shows an exemplary resume 1700 that may be used to apply for a job posting. The resume 1700 may also be available on a profile of an account. According to one embodiment, the resume 1700 is automatically created by the resume creation module 710 of FIG. 7 when a job applicant selects the application option 1608 of a job posting 1600 (see FIG. 16). The resume 1700 includes an indicator section 1702, a professional introduction section 1704, a professional experience matrix 1706, and a detailed resume 1708.

The indicator section 1702 may be similar to the indicator section 1602 of FIG. 16 in that it shows indicators 1407 reflecting the degree of match between the applicant's attributes and the job posting. According to one embodiment, this section may be dynamically updated in that the indicators are updated every time a job application is accessed. For example, every time an employer access a job application submitted by a job applicant, the indicators are updated to reflect the match between the most recent dashboard attributes of the applicant and the job posting. This may help to limit doctoring the attributes or work experience to coincide with a particular job posting.

The professional introduction section 1704 may be pulled from a user profile of the job applicant or text may be entered and/or edited at the time of application. This section may also be dynamically updated to reflect the most current professional introduction available in a user's profile. The professional experience matrix 1706 may also be pulled from a user's profile. Once again, this section may be dynamically updated. The detailed resume section 1708 may also be pulled from a user's profile. This section may include a similar layout as a traditional resume. Once again, this section may be dynamically updated. The resume 1700 may also include a cover letter section in some embodiments. This may be a text editable field where a user can create a custom letter applicable to the job posting.

According to varying embodiments each of the above sections 1702-1706 may be dynamically updated, may be static, and/or may be editable at the time of application.

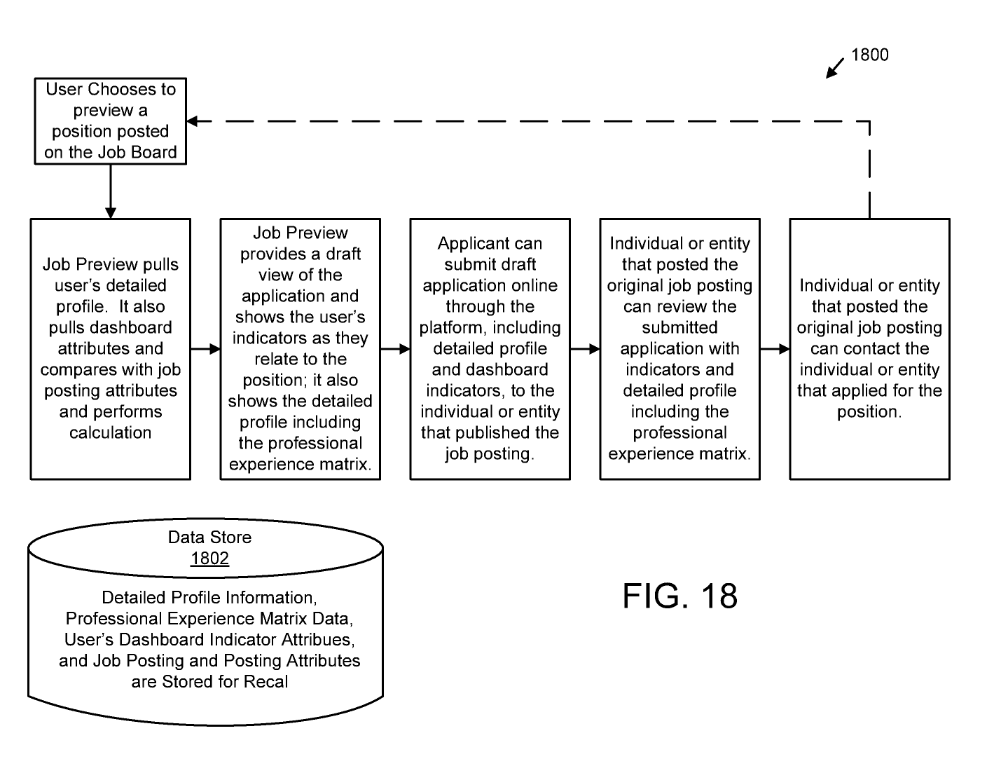

FIG. 18 depicts a schematic block diagram illustrating exemplary operations 1800 a of a job board in connection with a social network. According to the depicted embodiment the job board is in communication with a data store 1802.

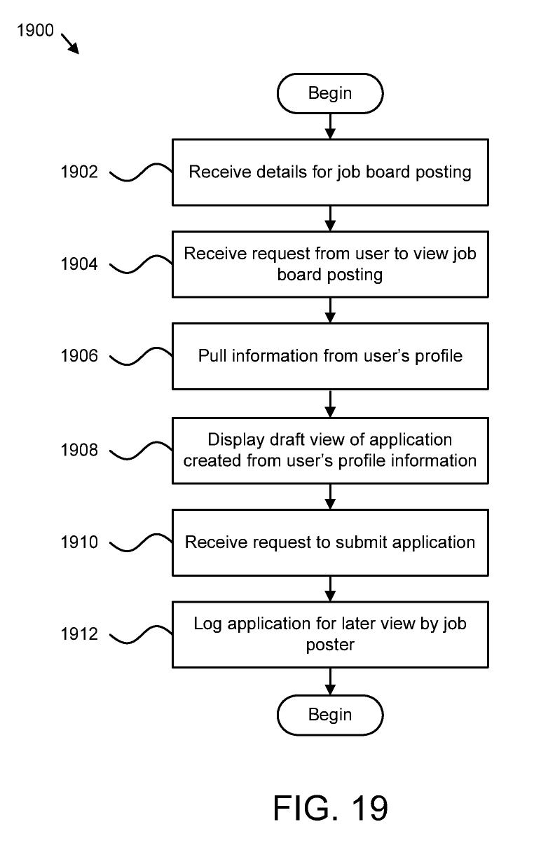

FIG. 19 depicts a schematic flow chart diagram illustrating an exemplary method 1900 of receiving job applications. According to one embodiment, the method 1900 may be embodied in instructions by a job board module 110 executable by a processor.

The method 1900 begins and details for a job board posting are received 1902. The details may be received when a user posts a new job board posting. For example, a user may access the social network apparatus 100 remotely over a network and provide details for the job posting. In one embodiment, a system comprising the modules 102-110 provides web pages accessible over the internet for utilizing its functionality.

In one embodiment, the details for the job board posting are received 1902 from a user on an account, such as an account of one of the previously discussed account types 300-306. In one embodiment, the job board posting is posted by a potential customer using a customer account 302 in order to find a consultant to provide services to the customer.

In one embodiment, the job board module 110 provides an interface for entering job board details. In one embodiment, the interface may provide drop down boxes, fields, or any other graphical elements to facilitate organized entry of details of the job posting. The interface may request details regarding desired work experience, desired attributes, or any other qualifications. In one embodiment, a user may enter job board details in a manner similar to that illustrated in FIGS. 8 and 9 in relation to the professional experience matrix. In one embodiment, a user may enter job board details in a manner similar to that illustrated in FIGS. 10 and 11 in relation to dashboard attributes.

After receiving 1902 the details for the job board posting, the job board module 110 may make the job board posting available to be viewed by accounts of a social network.

The job board module 110 may receive 1904 a request to view the job board posting. According to one embodiment, a user of a consultant account 304 searches for and finds the job board posting. The user may request to view the job board posting by selecting a link for the posting.

In response to receiving 1904 the request from the user to view the job board posting, the job board module 110 may pull 1906 information from the requesting user's account profile. The job board module 110 may pull 1906 the user's dashboard attributes, professional experience matrix, and or other information from the user's account profile.

The job board module 110 may display 1908 a draft view of an application created from the user's profile. According to one embodiment, the information from the user's profile may be compared to the details of the job board posting. In one embodiment, the indicator module 106 may display indicators showing how well the user matches up with the job board posting. The draft view of the application displayed 1908 by the job board module may reflect how the application will appear to the job poster. For example, the indicators and information from the user's profile may be displayed similar to a resume of FIG. 17. This may enable the user to understand what the job poster may see if the user posts an application.

In one embodiment, the user may be able to edit one more portions of the draft view of the application. In one embodiment, the user may be able to write a custom professional introduction (such as by modifying the professional introduction section 1704 of FIG. 17) or write or modify a detailed resume (such as the detailed resume field 1708 of FIG. 17). In one embodiment, the user cannot modify some portions of the draft view of the application. For example, a user may not be allowed to modify details in an indicator section 1702 on the draft. The user may be required to update these dashboard attributes in the user's profile instead. As another example, a user may not be able to modify the professional experience matrix section 1706 of the draft.

The job board module 110 may receive 1910 a request to submit the application. The user may submit a request when the user is satisfied that the draft application is in condition to be submitted. For example, the user may view the draft view of the application displayed 1908 by the job board module and then request that the application be submitted. The job board module 110 may receive 1910 this request and log 1912 the application for later view by the job poster.

The application may be logged 1912 by saving a version of the application to a data store for later retrieval. In one embodiment, only portions of the application are saved. For example, in the embodiment of FIG. 17 only professional introduction section 1704 and a detailed resume section 1708, and an identifier of the applicants account may be saved. According to one embodiment, portions of the application that are not saved are updated from a user profile of the applicant each time the job poster views the applicant. This may help ensure that the dashboard attributes of a user profile and a professional experience matrix are kept up to date by a user. This may also discourage users from modifying these indicators for a specific position.

In one embodiment, each time the submitted application is viewed one or more aspects of the submitted application may be updated to reflect the profile used to submit the application. For example, the indicators, dashboard attributes, resume, professional experience matrix, or other information may be dynamic such that a change to the account profile will be reflected in job applications submitted before the change was made to the profile. In this manner, job posters may be able to see how the status or attributes of applicants may have changed since they submitted applications for the position.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for providing a social network, the apparatus comprising:
a computer readable storage medium storing computer readable program code executable by a processor, the computer readable program code comprising:
an account module for managing a plurality of account types, the account types comprising a first account type, a second account type, and an administrator account type;
a connection module for allowing forming of connections between specific accounts wherein the connections are allowed to be formed based on at least the account types of the specific accounts; and
a network visibility module for regulating the amount of details of an account to be visible to other accounts, wherein the visibility of details of the account are based on at least the account types of the other accounts,
wherein accounts of different types comprise permissions that are unequal in relation to each other, each level of permissions including limitations at least partially defined by one or more of the connection module and the network visibility module.

2. The apparatus of claim 1, wherein an account of the first account type comprises permissions that allow a first level of access to an account of the second account type and the account of the second account type comprises a second level of access to the account of the first account type, wherein the first level of access is less than the second level of access.

3. The apparatus of claim 2, wherein the first level of access comprises not being allowed to see the existence of the account of the second account type and wherein the second level of access comprises being allowed to see the existence of the account of the first account type.

4. The apparatus of claim 2, wherein the first level of access comprises not being allowed to initiate a connection to the account of the second account type and wherein the second level of access comprises being allowed to initiate a connection to the account of the first account type.

5. The apparatus of claim 1, wherein the first account type comprises an account for one or more of a service provider and a goods provider.

6. The apparatus of claim 5, wherein the first account type comprises an account for consultants.

7. The apparatus of claim 1, wherein the second account type comprises an account for one or more of a purchaser of goods and a purchaser of services.

8. The apparatus of claim 7, wherein the second account type comprises an account for customers.

9. The apparatus of claim 1, wherein an administrator account type comprises unrestricted access to see the existence of accounts of all account types and non-private data stored by all account types.

10. The apparatus of claim 1, further comprising a query module configured to provide one or more search features for locating one or more accounts.

11. The apparatus of claim 1, wherein accounts of the first account type form a first network and accounts of the second account type form a second network, wherein the social network comprises the first network and the second network.

12. The apparatus of claim 1, wherein the second account type comprises a silo account type, wherein the silo account type is granted administrator like permissions to one or more accounts of the first account type based on a matching detail found in each of the one or more accounts of the first account type.

13. The apparatus of claim 12, wherein the administrator like permissions comprise unrestricted access to see the existence of accounts of the one or more accounts of the first account type and non-private data stored by the one or more accounts of the first account type.

14. The apparatus of claim 1, further comprising a profile module for receiving and storing one or more details entered in relation to an account.

15. A computer program product for providing a social network, the computer program product comprising:
a computer readable storage medium having computer readable program code embodied therein, the computer readable program code configured to conduct the operations of:
managing a plurality of account types, the account types comprising a first account type, a second account type, and an administrator account type;
allowing forming of connections between specific accounts wherein the connections are allowed to be formed based on at least the account types of the specific accounts; and
regulating the amount of details of an account to be visible to other accounts, wherein the visibility of details of the account are based on at least the account types of the other accounts,
wherein accounts of different types comprise permissions that are unequal in relation to each other, each level of permissions including limitations at least partially defined by the allowing forming of connections and the regulating the amount of details that are visible.

16. The computer program product of claim 15, wherein an account of the first account type comprises permissions that allow a first level of access to an account of the second account type and the account of the second account type comprises a second level of access to the account of the first account type, wherein the first level of access is less than the second level of access.

17. The computer program product of claim 16, wherein the first level of access comprises not being allowed to initiate a connection to the account of the second account type and wherein the second level of access comprises being allowed to initiate a connection to the account of the first account type.

18. The computer program product of claim 15, wherein the second account type comprises a silo account type, wherein the silo account type is granted administrator like permissions to one or more accounts of the first account type based on a matching detail found in each of the one or more accounts of the first account type.

19. The computer program product of claim 15, wherein the plurality of account types further comprises one or more account types in addition to the first account type, the second account type, and the administrator account type.

20. A method for deploying or integrating a computer program product, comprising integrating computer readable program code into a computing system, wherein the code in combination with the computing system performs the following:
managing a plurality of account types, the account types comprising a first account type, a second account type, and an administrator account type;
allowing forming of connections between specific accounts wherein the connections are allowed to be formed based on at least the account types of the specific accounts; and
regulating the amount of details of an account to be visible to other accounts, wherein the visibility of details of the account are based on at least the account types of the other accounts,
wherein accounts of different types comprise permissions that are unequal in relation to each other, each level of permissions including limitations at least partially defined by the allowing forming of connections and the regulating the amount of details that are visible.
